(19) United States
(12) Patent Application Publication
(10) Pub. No.: US 2022/0300119 A1
(43) Pub. Date: Sep. 22, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Shinsuke TSUDA, Kanagawa (JP)

(73) Assignee: FUJIFILM Business Innovation Corp., Tokyo (JP)

(21) Appl. No.: 17/395,488

(22) Filed: Aug. 6, 2021

(30) Foreign Application Priority Data
Mar. 17, 2021 (JP) 2021-043971

(51) Int. Cl. G06F 3/0481

(52) U.S. Cl. CPC G06F 3/0481

(57) ABSTRACT

An information processing apparatus includes a processor configured to generate a first virtual desktop for displaying a user interface environment of a first application in a desktop region of a display unit and a second virtual desktop for displaying a user interface environment of a second application in the desktop region of the display unit, and in a case where information regarding a status from the second application received while the first virtual desktop is displayed on the display unit satisfies a condition, perform control such that the second virtual desktop is displayed instead of the first virtual desktop displayed on the display unit.

### CROSS-REFERENCE TO RELATED APPLICATIONS

This application is based on and claims priority under 35 USC 119 from Japanese Patent Application No. 2021-043971 filed Mar. 17, 2021.

### BACKGROUND

### (i) Technical Field

The present invention relates to an information processing apparatus and a non-transitory computer readable medium storing an information processing program.

### (ii) Related Art

JP2014-139749A discloses a technique that determines whether a user interface (UI) environment provided currently is a first UI environment or a second UI environment, in a case where determination is made that the UI environment provided currently is the first UI environment, displays a first on-printing input screen in the first UI environment, and in a case where determination is made that the UI environment provided currently is the second UI environment, displays a second on-printing input screen in the second UI environment.

JP2014-041526A discloses a technique that, in a case where a first UI mode is identified, displays notification information on a display screen based on the first UI mode in association with a display instruction, and in a case where a second UI mode is identified, displays notification information transmitted from external equipment on a display screen based on the second UI mode, in association with a display instruction.

### SUMMARY

Incidentally, each of a plurality of applications has a user interface environment that displays a status, such as operation situations of the application and an apparatus to be managed by the application, or receives an operation of a user. In a case where a plurality of applications are operated on a plurality of operating systems (OSs) or personal computers (PCs), to perform the display or the operation on one display device, for example, a plurality of virtual desktops are used and the virtual desktops are switched to operate a plurality of applications. In this case, when one application is brought into a status where a user's confirmation or operation is needed, in a case where a virtual desktop for another application is displayed, there is a concern that the status where the user's confirmation or operation is needed is overlooked.

Aspects of non-limiting embodiments of the present disclosure relate to an information processing apparatus and a non-transitory computer readable medium storing an information processing program that, in a case where a plurality of applications are operated using a plurality of virtual desktop on one display device, improve visibility of change in status of each application compared to a configuration in which control for deciding which of a plurality of virtual desktops is to be displayed is performed without depending on a situation of an application.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to generate a first virtual desktop for displaying a user interface environment of a first application in a desktop region of a display unit and a second virtual desktop for displaying a user interface environment of a second application in the desktop region of the display unit, and in a case where information regarding a status from the second application received while the first virtual desktop is displayed on the display unit satisfies a condition, perform control such that the second virtual desktop is displayed instead of the first virtual desktop displayed on the display unit.

### BRIEF DESCRIPTION OF THE DRAWINGS

Exemplary embodiment(s) of the present invention will be described in detail based on the following figures, wherein:

FIG. 1 is a diagram showing the schematic configuration of an information processing system according to an exemplary embodiment;

FIG. 2 is a block diagram showing the hardware configuration of an information processing apparatus;

FIG. 3 is a block diagram showing an example of the functional configuration of the information processing apparatus;

FIG. 4 is a diagram showing a specific example of switching control of virtual desktops by the information processing apparatus;

FIG. 5 is a diagram showing a specific example of switching control of the virtual desktops by the information processing apparatus;

FIG. 6 is a diagram showing a specific example of switching control of the virtual desktops by the information processing apparatus;

FIG. 7 is a diagram showing a specific example of switching control of the virtual desktops by the information processing apparatus;

FIG. 8 is a flowchart showing a flow of information processing by the information processing apparatus; and

FIG. 9 is a flowchart showing a flow of the information processing by the information processing apparatus.

### DETAILED DESCRIPTION

Hereinafter, an example of an exemplary embodiment of the present disclosure will be described referring to the drawings. In the respective drawings, identical or equivalent constituent elements and portions are represented by identical reference numerals. The ratio of the dimensions in the respective drawings is exaggerated for convenience of description and is different from the actual ratio in some cases.

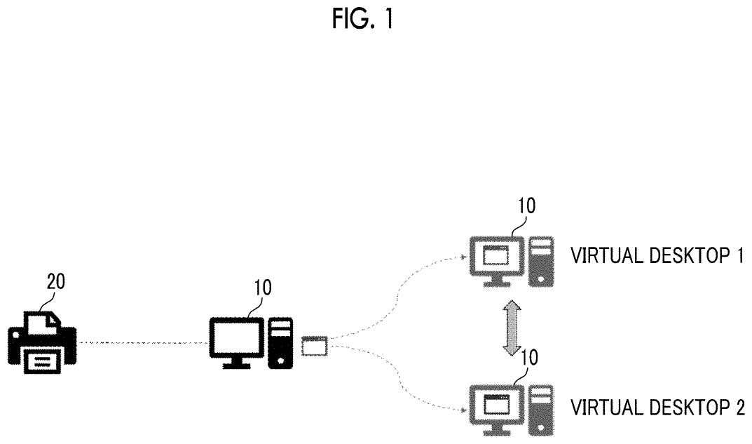

FIG. 1 is a diagram showing the schematic configuration of an information processing system according to the exemplary embodiment.

The information processing system shown in FIG. 1 has an information processing apparatus 10 and an image forming apparatus 20.

The information processing apparatus 10 is an apparatus that manages the image forming apparatus 20. An operating system (OS) that is executed by the information processing apparatus 10 is an OS in which a virtual desktop function is executable. In the exemplary embodiment, the information processing apparatus 10 generates at least two virtual desktops in advance. Then, in the exemplary embodiment, the information processing apparatus 10 generates a virtual desktop (virtual desktop 1) that displays a UI of an application for managing a job of the image forming apparatus 20, and a virtual desktop (virtual desktop 2) that displays a UI of an application for managing a status of the image forming apparatus 20.

In a case where the information processing apparatus 10 generates a plurality of virtual desktops, display between the virtual desktops is switched by a user's operation. The user's operation includes an input of a shortcut key of a keyboard, a swipe operation on a screen, and the like.

As a plurality of virtual desktops are generated by the information processing apparatus 10, and a UI of an application having a different function is displayed on each virtual desktop, it is possible to make one information processing apparatus 10 execute a plurality of functions without preparing different information processing apparatuses 10.

The information processing apparatus 10 can display only one virtual desktop on one screen. Accordingly, in a case where any change occurs in a UI of an application displayed on a virtual desktop that is not displayed, a user of the information processing apparatus 10 hardly instantly notices the change. Although a method of making a sound to notify that any change occurs is known, the user does not always make a setting such that a sound is emitted from the information processing apparatus 10. For this reason, in a case where the setting is not made such that a sound is emitted from the information processing apparatus 10, the user cannot notice that a sound is made.

Accordingly, the information processing apparatus 10 according to the exemplary embodiment has an object to improve visibility of change in status of each application compared to a configuration in which control for deciding which of a plurality of virtual desktops is to be displayed is performed without depending on a situation of an application.

In FIG. 1, although the image forming apparatus 20 is shown as an example of an apparatus that is managed by the information processing apparatus 10, the apparatus that is managed by the information processing apparatus 10 is not limited to the image forming apparatus 20. For the apparatus that is managed by the information processing apparatus 10, any type may be applied as long as an apparatus can perform communication via a network and can notify the outside of a situation. For example, Internet of Things (IoT) equipment that can perform wireless communication may be applied as the apparatus that is managed by the information processing apparatus 10.

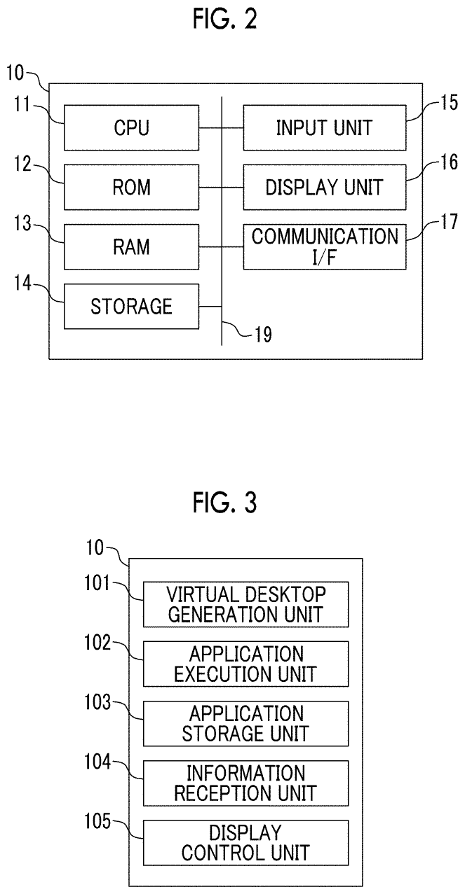

FIG. 2 is a block diagram showing the hardware configuration of the information processing apparatus 10.

As shown in FIG. 2, the information processing apparatus 10 has a central processing unit (CPU) 11, a read only memory (ROM) 12, a random access memory (RAM) 13, a storage 14, an input unit 15, a display unit 16, and a communication interface (I/F) 17. The respective configurations are connected in a communicable manner via a bus 19.

The CPU 11 is a central arithmetic processing unit and executes various programs or controls the respective units. That is, the CPU 11 reads a program from the ROM 12 or the storage 14 and executes the program with the RAM 13 as a work area. The CPU 11 controls the respective configurations described above and executes various kinds of arithmetic processing in association with the programs recorded in the ROM 12 or the storage 14. In the exemplary embodiment, an information processing program that generates virtual desktops to manage the image forming apparatus 20 is stored in the ROM 12 or the storage 14.

The ROM 12 stores various programs and various kinds of data. The RAM 13 temporarily stores a program or data as a work area. The storage 14 is configured with a storage device, such as a hard disk drive (HDD), a solid state drive (SSD), or a flash memory, and stores various programs including an operating system and various kinds of data.

The input unit 15 includes a pointing device, such as a mouse, and a keyboard and is used to perform various inputs.

The display unit 16 is, for example, a liquid crystal display, and displays various kinds of information. The display unit 16 may employ a touch panel system to function as the input unit 15.

The communication interface 17 is an interface for communication with other kinds of equipment, such as the image forming apparatus 20, and for example, the standard, such as Ethernet (Registered Trademark), FDDI, or Wi-Fi (Registered Trademark), is used.

In executing the above-described information processing program, the information processing apparatus 10 realizes various functions using the above-described hardware resources. The functional configuration that is realized by the information processing apparatus 10 will be described.

FIG. 3 is a block diagram showing an example of the functional configuration of the information processing apparatus 10.

As shown in FIG. 3, the information processing apparatus 10 has, as the functional configurations, a virtual desktop generation unit 101, an application execution unit 102, an application storage unit 103, an information reception unit 104, and a display control unit 105. Each functional configuration is realized by the CPU 11 reading the information processing program stored in the ROM 12 or the storage 14 and executing the information processing program.

The virtual desktop generation unit 101 generates a plurality of virtual desktops. Specifically, the virtual desktop generation unit 101 generates a plurality of virtual desktops that show display screen information for displaying a user interface environment including a status related to an operation situation of an application in a desktop region of the display unit 16 and corresponds to a plurality of set applications.

In the exemplary embodiment, the virtual desktop generation unit 101 generates at least a virtual desktop (virtual desktop 1) that displays a UI of an application for managing a job of the image forming apparatus 20, and a virtual desktop (virtual desktop 2) that displays a UI of an application for managing the status of the image forming apparatus 20. Although a timing at which the virtual desktop generation unit 101 generates the virtual desktops is not limited, for example, the virtual desktop generation unit 101 generates the virtual desktops when the information processing apparatus 10 is activated.

The application execution unit 102 reads an application stored in the application storage unit 103 and executes the application. On each virtual desktop generated by the virtual desktop generation unit 101, the application execution unit 102 executes the application corresponding to the virtual desktop. That is, the application execution unit 102 executes the application for managing a job of the image forming apparatus 20 on the virtual desktop 1, and executes the application for managing the status of the image forming apparatus 20 on the virtual desktop 2.

Furthermore, the application execution unit 102 executes a launcher application for calling the application that is executed on each virtual desktop. A timing at which the application execution unit 102 activates the launcher application is, for example, when the information processing apparatus 10 is activated.

The application execution unit 102 may execute a plurality of applications on one virtual desktop.

The application storage unit 103 stores the applications that are executed by the application execution unit 102. In the exemplary embodiment, the application storage unit 103 stores at least the application for managing a job of the image forming apparatus 20, the application for managing the status of the image forming apparatus 20, and the launcher application for calling such applications.

The information reception unit 104 receives information for switching display of the virtual desktops generated by the virtual desktop generation unit 101. Information for switching display of the virtual desktops includes, for example, information corresponding to an input a predetermined shortcut key of a keyboard and information corresponding to a swipe operation on the display unit 16. Information for switching display of the virtual desktops includes information indicating change in status of a plurality of applications.

The display control unit 105 performs display control on the display unit 16. The display control that is executed by the display control unit 105 includes, for example, display control of the UI of the application that is executed on each virtual desktop generated by the virtual desktop generation unit 101. The display control that is executed by the display control unit 105 includes display control regarding switching between the virtual desktop corresponding to information received by the information reception unit 104.

Then, in a case where the information reception unit 104 receives information indicating the change in status, the display control unit 105 performs display control for switching display from a certain virtual desktop (first virtual desktop) to another virtual desktop (second virtual desktop) corresponding to an application relevant to the received information indicating the change in status on the display unit 16 in association with the reception. For example, in a case where the virtual desktop 1 is displayed on the display unit 16, and in a case where information indicating change in status of the application displayed on the virtual desktop 2 is received, the display control unit 105 performs display control for switching display to the virtual desktop 2.

In a case of performing display control for switching the virtual desktop to be displayed, the display control unit 105 may perform control for further displaying identification information for identifying the application on the virtual desktop after switching. For example, the display control unit 105 may perform control for further displaying a name of the application on the virtual desktop after switching.

In a case of performing display control for switching the virtual desktop to be displayed, the display control unit 105 may perform control for further displaying a user interface environment of the application that is executed on the virtual desktop after switching. For example, the display control unit 105 may perform control for highlighting information corresponding to information indicating the change in status in the user interface environment of the application that is executed on the virtual desktop after switching. The information processing apparatus 10 performs control such that display is performed on the virtual desktop including the user interface environment of the application, whereby the user easily notices the change compared to a case where control is performed such that display is performed without including the user interface environment.

The application execution unit 102 may perform control for executing processing of the application that is executed on the virtual desktop after switching, with priority over processing of the application that is executed on the virtual desktop before switching, after the display control unit 105 switches the virtual desktop.

For example, the application execution unit 102 may perform control for executing the processing of the application that is executed on the virtual desktop after switching, based on set priority information. The priority information is information indicating that priority is given over the application executed on the virtual desktop before switching, and indicating at least one of a degree of priority indicating a degree of executing the processing of the application with priority or a usage rate of the CPU 11 in executing the application.

For example, in a case where the virtual desktop 1 is displayed on the display unit 16, the application execution unit 102 may set the usage rate of the CPU 11 on the application executed on the virtual desktop 1 to be higher than the usage rate of the CPU 11 on the application executed on the virtual desktop 2. For example, in a case where the virtual desktop 1 is displayed on the display unit 16, the application execution unit 102 may set an allocation amount of the RAM 13 that is used by the application executed on the virtual desktop 1, to be higher than an allocation amount of the RAM 13 that is used by the application executed on the virtual desktop 2.

As described above, the information processing apparatus 10 can generate a plurality of virtual desktops and can switch and display the virtual desktops on the display unit 16 in association with reception of information for switching display of the virtual desktops. A specific example of the switching control of the virtual desktop by the information processing apparatus 10 is shown.

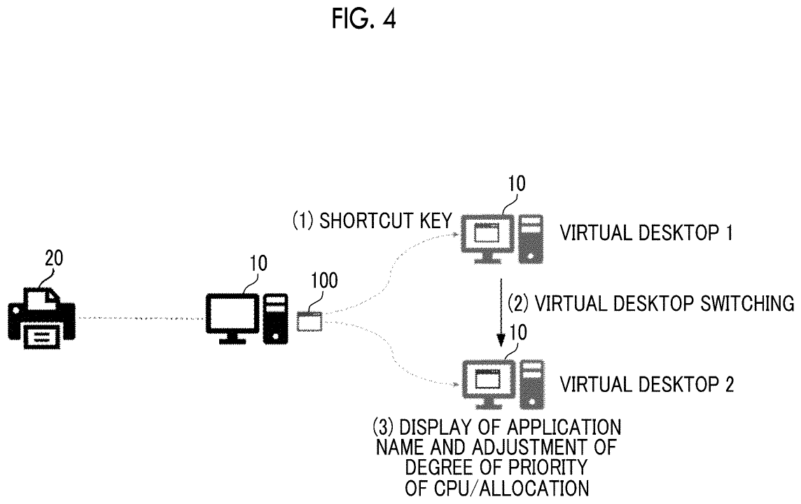

FIG. 4 is a diagram showing a specific example of switching control of the virtual desktops by the information processing apparatus 10. FIG. 4 shows an example where the virtual desktops are switched depending on an input of a shortcut key of a keyboard. The application that is executed on the virtual desktop is activated by a launcher application 100. The information processing apparatus 10 that detects an input of a predetermined shortcut key switches the virtual desktop to be displayed on the display unit 16 depending on the input. In the example of FIG. 4, a case where display is switched from the virtual desktop 1 to the virtual desktop 2 is shown. The information processing apparatus 10 may display the name of the application executed on the virtual desktop as a switching destination on the display unit 16. The information processing apparatus 10 may increase the degree of priority of the CPU 11 on the application executed on the virtual desktop as a switching destination. The information processing apparatus 10 may increase the allocation amount of the RAM 13 on the application executed on the virtual desktop as a switching destination.

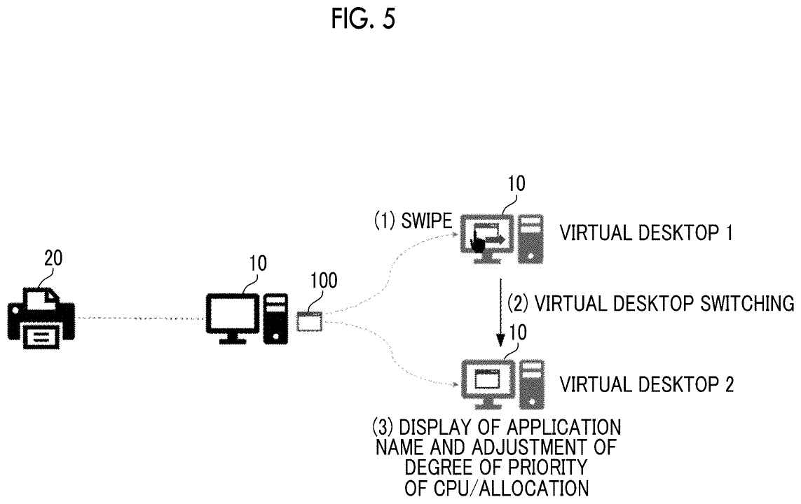

FIG. 5 is a diagram showing a specific example of switching control of the virtual desktops by the information processing apparatus 10. FIG. 5 shows an example where the virtual desktops are switched depending on a swipe operation on the display unit 16 by the user of the information processing apparatus 10. The information processing apparatus 10 that detects the swipe operation switches the virtual desktop to be displayed on the display unit 16 depending on the operation. In the example of FIG. 5, a case where display is switched from the virtual desktop 1 to the virtual desktop 2 is shown. In the example of FIG. 5, similarly, the information processing apparatus 10 may perform the display of the name of the application, the adjustment of the degree of priority of the CPU 11, and the adjustment of the allocation amount of the RAM 13.

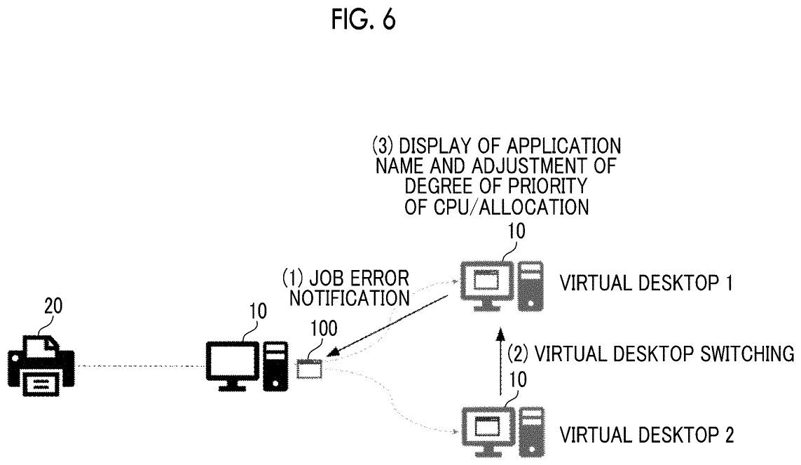

FIG. 6 is a diagram showing a specific example of switching control of the virtual desktops by the information processing apparatus 10. FIG. 6 shows an example where the virtual desktops are switched with the occurrence of an error of a job of the image forming apparatus 20 as a trigger. The information processing apparatus 10 switches the virtual desktop to be displayed on the display unit 16 from the virtual desktop 2 to the virtual desktop 1 depending on the occurrence of an error of a job of the image forming apparatus 20. In the example of FIG. 6, similarly, the information processing apparatus 10 may perform the display of the name of the application, the adjustment of the degree of priority of the CPU 11, and the adjustment of the allocation amount of the RAM 13.

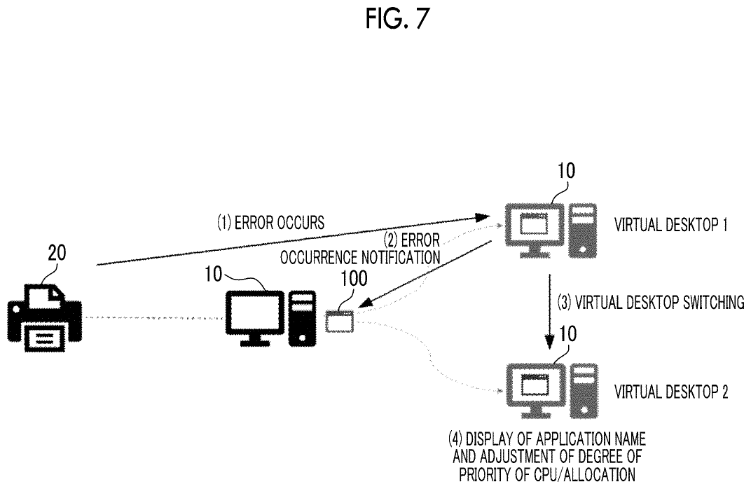

FIG. 7 is a diagram showing a specific example of switching control of the virtual desktops by the information processing apparatus 10. FIG. 7 shows an example where the virtual desktops are switched with the occurrence of an error in the image forming apparatus 20 as a trigger. The information processing apparatus 10 switches the virtual desktop to be displayed on the display unit 16 from the virtual desktop 1 to the virtual desktop 2 depending on the occurrence of an error of the image forming apparatus 20. In the example of FIG. 7, similarly, the information processing apparatus 10 may perform the display of the name of the application, the adjustment of the degree of priority of the CPU 11, and the adjustment of the allocation amount of the RAM 13.

Next, the operations of the information processing apparatus 10 will be described.

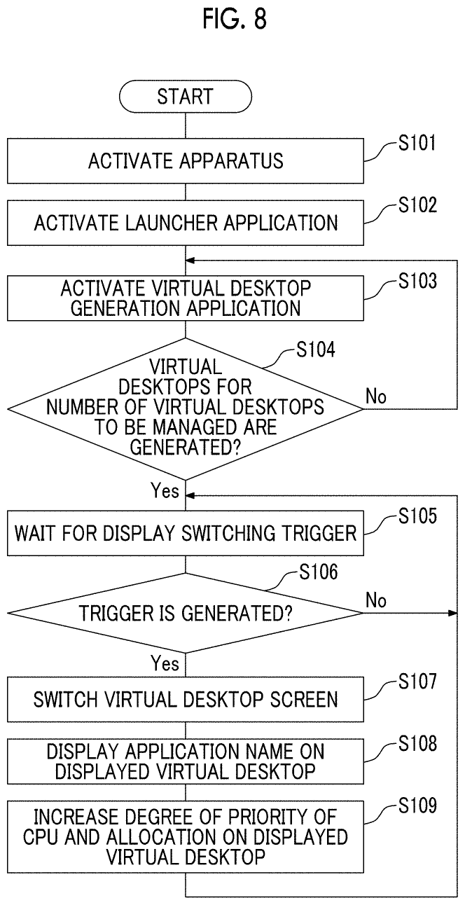

FIG. 8 is a flowchart showing a flow of information processing by the information processing apparatus 10. The CPU 11 reads the information processing program from the ROM 12 or the storage 14, develops the information processing program to the RAM 13, and executes the information processing program, whereby the information processing is executed.

In a case where the information processing apparatus 10 is activated (Step S101), the CPU 11 activates the launcher application set to be activated when the information processing apparatus 10 is activated (Step S102).

In a case where the launcher application is activated, subsequently, the CPU 11 activates a virtual desktop generation application for generating virtual desktops (Step S103).

In a case where the virtual desktop generation application is activated, subsequently, the CPU 11 determines whether or not the virtual desktops are generated by the virtual desktop generation application for the number of virtual desktops to be managed (Step S104). Ina case where the virtual desktops are not generated for the number of virtual desktops to be managed (Step S104; No), the CPU 11 repeats the determination processing of Step S104 until the virtual desktops are generated for the number of virtual desktops to be managed. In a case where the virtual desktops are generated for the number of virtual desktops to be managed (Step S104; Yes), subsequently, the CPU 11 waits for the occurrence of a trigger for switching display of the virtual desktops (Step S105).

The CPU 11 determines whether or not the trigger for switching display of the virtual desktops occurs (Step S106). In a case where the trigger for switching display of the virtual desktops does not occur (Step S106; No), the CPU 11 returns to Step S105 and waits for the occurrence of the trigger for switching display of the virtual desktops. In a case where the trigger for switching display of the virtual desktops occurs (Step S106; Yes), the CPU 11 switches the screen display of the virtual desktop depending on the trigger (Step S107).

Ina case where the screen display of the virtual desktops is switched depending on the trigger, subsequently, the CPU 11 displays the name of the application executed on the virtual desktop on the virtual desktop after switching (Step S108). The CPU 11 increases the degree of priority of the CPU 11 and the allocation amount of the memory (RAM 13) on the application executed on the virtual desktop after switching (Step S109). In a case where the processing of Step S109 ends, the CPU 11 returns to waiting for the occurrence of the trigger in Step S105.

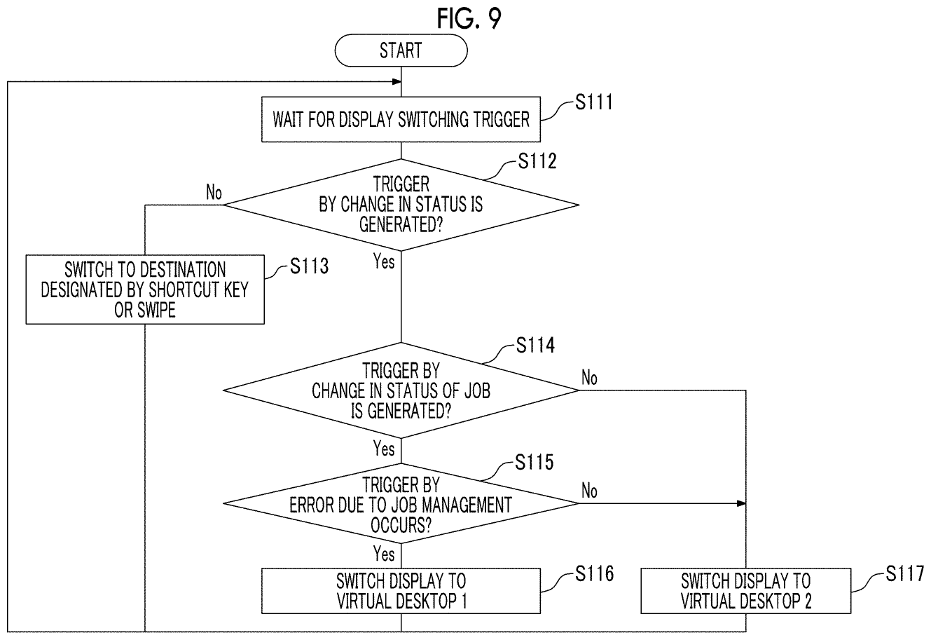

FIG. 9 is a flowchart showing a flow of the information processing by the information processing apparatus 10. The CPU 11 reads the information processing program from the ROM 12 or the storage 14, develops the information processing program to the RAM 13, and executes the information processing program, whereby the information processing is executed.

The flowchart shown in FIG. 9 is a flowchart showing details of processing for switching the virtual desktop to be displayed depending on the occurrence of the trigger for switching display of the virtual desktops.

In a state of waiting for the occurrence of the trigger for switching display of the virtual desktops (Step S111), the CPU 11 determines whether or not a trigger by change in status of the image forming apparatus 20 occurs (Step S112).

In a case where determination is made that there is no trigger by the change in status of the image forming apparatus 20 (Step S112; No), the CPU 11 switches display to the virtual desktop as a switching destination designated by an input of a shortcut key or a swipe operation (Step S113).

On the other hand, in a case where determination is made that there is the trigger by the change in status of the image forming apparatus 20 (Step S112; Yes), the CPU 11 determines whether or not a trigger by change in status of a job occurs (Step S114).

In a case where determination is made that the trigger by the change in status of the job of the image forming apparatus 20 occurs (Step S114; Yes), subsequently, the CPU 11 determines whether or not a trigger by an error due to job management of the image forming apparatus 20 occurs (Step S115).

In a case where determination is made that the trigger by the error due to the job management of the image forming apparatus 20 occurs (Step S115; Yes), subsequently, the CPU 11 performs display control for switching the virtual desktop to be displayed on the display unit 16 to the virtual desktop 1 (Step S116).

On the other hand, in a case where determination is made that there is no trigger by the change in status of the job of the image forming apparatus 20 (Step S114; No), subsequently, the CPU 11 performs display control for switching the virtual desktop to be displayed on the display unit 16 to the virtual desktop 2 (Step S117). In a case where determination is made that there is no trigger by the error due to the job management of the image forming apparatus 20 (Step S115; No), subsequently, the CPU 11 performs display control for switching the virtual desktop to be displayed on the display unit 16 to the virtual desktop 2 (Step S117).

With the execution of a series of operations described above, the information processing apparatus 10 can generate a plurality of virtual desktops and can switch and display the virtual desktops on the display unit 16 depending on reception of information for switching display of the virtual desktops.

Then, the information processing apparatus 10 can switch the virtual desktop to be displayed on the display unit 16 depending on the situation of the application for managing the image forming apparatus 20. Through the control for switching the virtual desktop to be displayed on the display unit 16 depending on the situation of the application for managing the image forming apparatus 20, the information processing apparatus 10 may improve visibility of the change in status of each application compared to a configuration in which control is performed without depending on the situation of the application.

Although the CPU executes the information processing by reading and executing software (program) in the above-described exemplary embodiment, various processors other than the CPU may execute the information processing. Examples of the processors in this case include a programmable logic device (PLD), such as a field-programmable gate array (FPGA), capable of changing a circuit configuration after manufacture, and a dedicated electric circuit that is a processor having a circuit configuration dedicatedly designed for executing specific processing, such as an application specific integrated circuit (ASIC). The information processing may be executed by one of various processors described above or may be executed by a combination of two or more processors (for example, a plurality of FPGAs and a combination of a CPU and an FPGA) of the same type or different types. The hardware structure of various processors is more specifically an electric circuit in which circuit elements, such as semiconductor elements, are combined.

In the above-described exemplary embodiment, although an aspect where the program of the information processing is stored (installed) in the ROM or the storage has been described, the invention is not limited thereto. The program may be provided in a form of being recorded in a non-transitory recording medium, such as a compact disk read only memory (CD-ROM), a digital versatile disk read only memory (DVD-ROM), or a universal serial bus (USB) memory. The program may be downloaded from an external apparatus via a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
a processor configured to:
generate a first virtual desktop for displaying a user interface environment of a first application in a desktop region of a display unit and a second virtual desktop for displaying a user interface environment of a second application in the desktop region of the display unit;
in a case where occurrence of a trigger for switching display from the first virtual desktop to the second virtual desktop is detected by the processor while the first virtual desktop is displayed on the display unit, wherein the trigger is corresponding to information regarding a status received from the second application, perform control to switch the display such that the second virtual desktop is displayed instead of the first virtual desktop displayed on the display unit; and
perform control for executing processing of an application that is executed in the second virtual desktop, with priority over processing of an application that is executed in the first virtual desktop.

2. The information processing apparatus according to claim 1, wherein the processor is configured to:
in a case of performing control for displaying the second virtual desktop, perform control for further displaying identification information for identifying an application in the second virtual desktop.

3. The information processing apparatus according to claim 2,
wherein the identification information is information indicating a name of an application in the second virtual desktop.

4. The information processing apparatus according to claim 1, wherein the processor is configured to:
in a case of performing control for displaying the second virtual desktop, perform control for further displaying a user interface environment of an application that is executed in the second virtual desktop.

5. The information processing apparatus according to claim 2, wherein the processor is configured to:
in a case of performing control for displaying the second virtual desktop, perform control for further displaying a user interface environment of an application that is executed in the second virtual desktop.

6. The information processing apparatus according to claim 3, wherein the processor is configured to:
in a case of performing control for displaying the second virtual desktop, perform control for further displaying a user interface environment of an application that is executed in the second virtual desktop.

7. The information processing apparatus according to claim 4, wherein the processor is configured to:
perform control for highlighting information indicating change in the status in the user interface environment of the application that is executed in the second virtual desktop.

8. The information processing apparatus according to claim 5, wherein the processor is configured to:
perform control for highlighting information indicating change in the status in the user interface environment of the application that is executed in the second virtual desktop.

9. The information processing apparatus according to claim 6, wherein the processor is configured to:
perform control for highlighting information indicating change in the status in the user interface environment of the application that is executed in the second virtual desktop.

10-17. (canceled)

18. The information processing apparatus according to claim 1, wherein the processor is configured to:
set priority information indicating that priority is given to an application that is executed in the second virtual desktop, over an application that is executed in the first virtual desktop and indicating at least one of a degree of priority indicating a degree of executing the processing of the application with priority or a usage rate of the processor in executing the application, and perform control for executing the processing of the application that is executed in the second virtual desktop, based on the set priority information.

19. The information processing apparatus according to claim 1,
wherein the first application and the second application execute a plurality of tasks related to one job, respectively.

20. A non-transitory computer readable medium storing an information processing program causing a computer to execute a process comprising:
generating a first virtual desktop for displaying a user interface environment of a first application in a desktop region of a display unit and a second virtual desktop for displaying a user interface environment of a second application in the desktop region of the display unit,
in a case where occurrence of a trigger for switching display from the first virtual desktop to the second virtual desktop is detected by the processor while the first virtual desktop is displayed on the display unit, wherein the trigger is corresponding to information regarding a status received from the second application, performing control to switch the display such that the second virtual desktop is displayed instead of the first virtual desktop displayed on the display unit, and
perform control for executing processing of an application that is executed in the second virtual desktop, with priority over processing of an application that is executed in the first virtual desktop.

21. The information processing apparatus according to claim 1, wherein a priority degree of the second virtual desktop currently displayed on the display unit is increased over a priority degree of the first virtual desktop after switching displaying on the display unit from the first virtual desktop to the second virtual desktop.
